(19) United States
(12) Patent Application Publication
(10) Pub. No.: US 2017/0111157 A1
(43) Pub. Date: Apr. 20, 2017

(54) SELF-PROMOTING MESH NETWORK NODE

(71) Applicant: Elephant Head, Inc., Denver, CO (US)

(72) Inventor: Aditya Nagrath, Denver, CO (US)

(21) Appl. No.: 15/297,753

(22) Filed: Oct. 19, 2016

Related U.S. Application Data
(60) Provisional application No. 62/243,409, filed on Oct. 19, 2015.
(60) Provisional application No. 62/243,419, filed on Oct. 19, 2015.

(51) Int. Cl. H04L 5/00; H04H 20/38; H04L 29/06; H04L 12/933

(52) U.S. Cl. CPC H04L 5/0091; H04L 49/1584; H04H 20/38; H04L 69/28

(57) ABSTRACT

A self-promoting mesh network node is described that renders manual designation of new mesh network nodes unnecessary. When joining a new mesh network, the self-promoting mesh network node broadcasts a series of up to three different types of signals and scans for a mesh network address received in response thereto. Upon receipt of a mesh network address, the self-promoting mesh network node adopts the address and sends a join message to the mesh network router or node that provided the address. Once part of a mesh network, the self-promoting mesh network node will send a promotion permission request to the mesh network router if it receives a coordinator promotion request from a new node attempting to join the network.

### CROSS REFERENCE TO RELATED APPLICATIONS

The present application claims, under 35 U.S.C. §119(e), the benefits of and priority to U.S. Provisional Application Ser. No. 62/243,409, filed on Oct. 19, 2015, entitled “Self-Promoting Mesh Network Node,” and U.S. Provisional Application Ser. No. 62/243,419, filed on Oct. 19, 2015, entitled “Configurable Sensor Trap,” the disclosures of which are hereby incorporated by reference in their entirety for all that they teach and for all purposes.

### FIELD

The present disclosure is generally directed to mesh networks, and more specifically to a device configured to automatically assume different roles within a mesh network as needed.

### BACKGROUND

A mesh network is a network topology comprising a plurality of nodes, where each node relays data for the network. The nodes in the network cooperate to distribute data in the network. Data can be distributed using a flooding or broadcast technique, where a message is sent to every node in the network regardless of whether a particular node is an intended recipient of the message, or using the routing technique, where the message is sent from one node to another until it reaches the intended recipient node. Nodes in a mesh network may operate as a data source or end node (placing new data on the mesh network, or receiving commands through the mesh network), a data forwarder or coordinator node (transmitting data from one node to another on the mesh network), or a data sink or router node (receiving data from various nodes on the mesh network, and in some instances, transmitting that data from the mesh network to a different network (e.g. the Internet) or location (e.g. a server or data storage facility)). Mesh network nodes often utilize wireless communication radios or transceivers to communicate with one or more other nodes in the network, which increases the ease of network setup and eliminates costly installation of wired connections between or among nodes.

### SUMMARY

Setting up a mesh network typically requires manual designation of each node in the mesh network as a data source/end node, data forwarder/coordinator node, or data sink/router node. Similarly, adding a new node to an existing mesh network requires configuring the newly added node, and may also require configuring one or more nodes on the communication path between the newly added node and the router. Manual designation of nodes increases the amount of time required to set up a mesh network or to add a new node to an existing mesh network, and introduces the possibility of user error during that process. Some attempts have been made at automatic designation of mesh network nodes, but these often require that newly added nodes store an address list of other mesh network nodes in local memory, which reduces the amount of available local memory and also adds extra processing steps (e.g. to lookup an address in the address list as part of the data communication process). The systems and methods of the present disclosure reduce the amount of memory required for mesh network administration in each mesh network node by eliminating the need for the storage of address lists is mesh network nodes, and also reduces the number of necessary processing steps.

In accordance with embodiments of the present disclosure, self-promoting mesh network nodes eliminate the need for manual designation of nodes during network setup or expansion, without relying upon address lists stored in node memory. Once a router is designated as the base of a mesh network, additional nodes can be added and will automatically configure themselves appropriately. A router as described herein may comprise one or more communications transceivers for communicating with the nodes of a mesh network and/or with a central server or another network via the cloud, a processor, and a memory storing instructions for the processor.

A self-promoting mesh network node according to one embodiment of the present disclosure comprises a wireless radio for communicating with other nodes in a mesh network; a processor; and a memory. The memory stores instructions configured to cause the processor to detect whether the self-promoting mesh network node has a mesh network address; broadcast a router search request from the wireless radio if no mesh network address is detected; broadcast a coordinator search request from the wireless radio if no mesh network address is received from a router in response to the router search request after a first predetermined period of time; broadcast a coordinator promotion request from the wireless communication interface if no mesh network address is received from a coordinator in response to the coordinator search request after a second predetermined period of time; and adopt a mesh network address received in response to one of the router search request, the coordinator search request, and the coordinator promotion request.

The memory may store additional instructions configured to further cause the processor to conduct additional operations. For example, the additional instructions may cause the processor to detect a coordinator promotion request received via the wireless radio; send a promotion permission request to a router; and adopt a coordinator address received from the router. The additional instructions may cause the processor to send a new mesh network address via the wireless radio in response to the coordinator promotion request; detect a join message received via the wireless radio; and send a message to the router including the new mesh network address.

Still further, the additional instructions may cause the processor to send a new mesh network address via the wireless radio in response to a coordinator search request; detect a join message received via the wireless radio; and send a message to a router including the new mesh network address. The additional instructions may cause the processor to send a join message to the node that sent the adopted mesh network address. The additional instructions may also cause the processor to select for adoption, based on a predetermined criterion, one of a plurality of mesh network addresses received in response to one of the router search request, the coordinator search request, and the coordinator promotion request. The predetermined criterion may be related to the order in which the plurality of mesh network addresses were received.

The memory may store yet other additional instructions configured to cause the processor to adopt the first one of a plurality of mesh network addresses received in response to one of the router search request, the coordinator search request, and the coordinator promotion request. The additional instructions may cause the processor to broadcast the router search request at predetermined intervals of time during the first predetermined period of time. The additional instructions may cause the processor to broadcast the coordinator search request at predetermined intervals of time during the second predetermined period of time. The additional instructions may be configured to cause the processor to rebroadcast the router search request if no response is received to the coordinator promotion request.

A method of automatically configuring nodes of a mesh network according to another embodiment of the present disclosure comprises broadcasting a router search request from a wireless radio on a mesh network node at predetermined intervals during a first period of time; scanning for a response to the router search request until the first period of time has expired; broadcasting a coordinator search request from the wireless radio at predetermined intervals during a second period of time, if no response to the router search request is detected; scanning for a response to the coordinator search request until the second period of time has expired; broadcasting a coordinator promotion request from the wireless radio at predetermined intervals during a third period of time, if no response to the coordinator search request is detected; and scanning for a response to the coordinator search request until the third period of time has expired.

The response to the router search request, the response to the coordinator search request, or the response to the coordinator promotion request may comprise a mesh network address. The method may further comprise sending a join message, via the wireless radio, after receipt of the response to one of the router search request, the coordinator search request, and the coordinator promotion request.

A self-promoting mesh network node according to yet another embodiment of the present disclosure comprises a communications transceiver for communicating with a plurality of nodes in a mesh network; a processor; and a memory. The memory stores instructions for causing the processor to detect a coordinator promotion request received via the communications transceiver; generate a promotion permission request; cause the promotion permission request to be sent to a mesh network router via the communications transceiver; detect a response received from the mesh network router; and determine, based on the response, whether the promotion permission request was granted by the mesh network router.

The memory may store additional instructions configured to cause the processor to perform other operations. For example, the additional instructions may be configured to cause the processor to adopt a new coordinator address contained within the response from the mesh network router; generate a confirmation message indicating that the new coordinator address has been adopted; and cause the confirmation message to be transmitted to the mesh network router via the communications transceiver.

The additional instructions may be configured to cause the processor generate a message comprising a mesh network identifier and a new mesh network address; and cause the message to be transmitted by the communications transceiver. Further additional instructions stored in the memory may cause the processor to detect a node identifier in the coordinator promotion request, the node identifier corresponding to a node that transmitted the coordinator promotion request; and further wherein the causing the message to be transmitted by the communications transceiver comprises causing the message to be transmitted by the communications transceiver to the node that transmitted the coordinator promotion request using the node identifier. Still additional instructions may cause the processor to scan for a join message after causing the message to be transmitted by the communications transceiver. The memory may also store additional instructions configured to cause the processor to report receipt of the joint message to the mesh network router.

The terms “memory,” “computer memory,” and “computer-readable medium,” as used herein, refer to any tangible data storage medium that participates in providing instructions to a processor for execution. Such a medium may take many forms, including but not limited to, non-volatile media, volatile media, and transmission media. Non-volatile media includes, for example, NVRAIVI, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read instructions. When the computer-readable medium is configured as part of a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The terms “determine,” “calculate,” and “compute,” and variations thereof, as used herein, are used interchangeably and include any type of methodology, process, mathematical operation, or technique.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of a self-promoting mesh network node according to one embodiment of the present disclosure;

FIG. 2A is a flowchart depicting a method according to another embodiment of the present disclosure;

FIG. 2B is a flowchart depicting additional aspects of the method of FIG. 2A;

FIG. 2C is a flowchart depicting further additional aspects of the method of FIGS. 2A and 2B;

FIG. 3 is a flowchart depicting another method according to an embodiment of the present disclosure; and

FIG. 4 is a flowchart depicting yet another method according to an embodiment of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Additionally, the use of phrases denoting examples (including “for example,” “by way of example,” “e.g.,” “such as,” and other similar phrases) indicates that what follows is only one example of a feature or aspect of the present disclosure, and is not intended to be limiting.

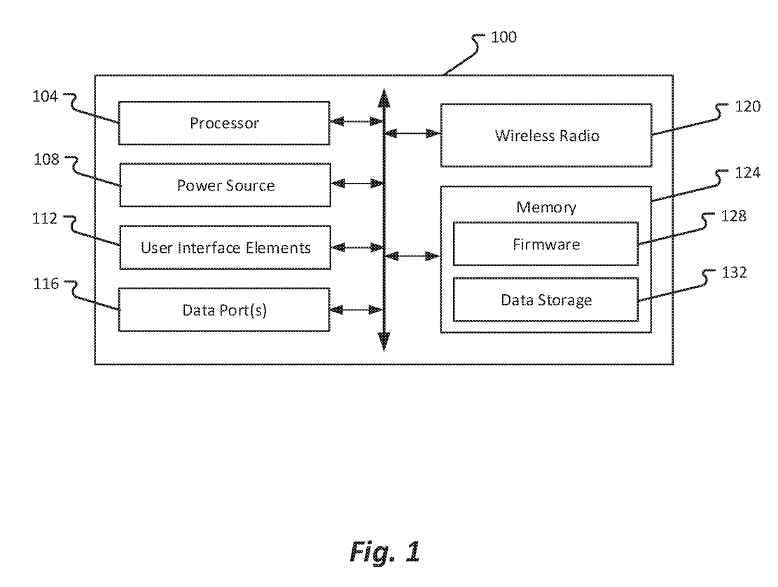

Referring first to FIG. 1, a potential mesh network node 100 according to embodiments of the present disclosure comprises a processor 104, a power source 108, one or more user interface elements 112, one or more data ports 116, a wireless radio 120, and a memory 124.

The processor 104 may correspond to one or multiple microprocessors that are contained within the housing of the mesh network node 100. The processor 104 may comprise a Central Processing Unit (CPU) on a single Integrated Circuit (IC) or a few IC chips. The processor 104 may be a multipurpose, programmable device that accepts digital data as input, processes the digital data according to instructions stored in its internal memory, and provides results as output. The processor 104 may implement sequential digital logic as it has internal memory. As with most known microprocessors, the processor 104 may operate on numbers and symbols represented in the binary numeral system.

The power supply 108 may comprise a built-in power supply (e.g., battery) and/or a power converter that facilitates the conversion of externally-supplied AC power into DC power that is used to power the various components of the mesh network node 100. In some embodiments, the power supply 108 may also include some implementation of surge protection circuitry to protect the components of the sensor trap 100 from power surges. Also in some embodiments, the power supply 108 may comprise an energy conversion device for converting non-electrical energy into electrical energy. Such a device may be or include, for example, a solar panel, a windmill, a generator, or a combination thereof.

The one or more user interface elements 112 allow a user or operator of the mesh network node 100 to control the mesh network node 100. The one or more user interface elements 112 may comprise, for example, one or more of: a power switch; one or more LED lights and/or a display screen for displaying a plurality of options, available settings, existing settings, operational data, and/or node status; and a mouse, one or more selection buttons, a keyboard, a trackpad, a touchscreen, and/or another input device for selecting between or among a plurality of options, and/or inputting configuration information or settings information.

In some embodiments, a node 100 according to the present invention may be configured to upload information through the mesh network on a periodic basis. Such information may be received via the one or more data ports 116, and may be transmitted via the wireless radio 120. The data port(s) 116 may comprise any now known or future developed data port, including an RJ45, 4P4C, 6P6C, USB, Firewire, Apple Lightning, DB9, DB25, and/or COM port. In addition to or instead of one or more wired data ports 116, the node 100 may also comprise one or more wireless data ports 116. For example, the wireless data ports 116 may comprise any one or more of a Wi-Fi, Bluetooth, Bluetooth Low Energy (BLE), ZigBee, Weigand, Radio Frequency Identification (RFID), or Near Field Communication (NFC) port. The information may be received from a sensor, actuator, or other device connected to the node 100 via the data port(s) 116. In some embodiments, the data port(s) 116 may also be used for providing information to the sensor, actuator, or other device connected to the node 100 via the data port(s) 116.

The wireless radio 120 comprises hardware that allows the node 100 to transmit data and otherwise communicate with other communication devices directly or over a communication network (e.g. a mesh network). As noted above, for example, the wireless radio 120 may be used for transmitting data received via the data port(s) 116 of the mesh network node 100 to another communication device. Additionally, the wireless radio 120 is used to establish and maintain participation in a mesh network, including by communicating with one or more nodes of a mesh network, as described more fully below. The wireless radio 120 may comprise a Wi-Fi card, a Network Interface Card (NIC), a cellular interface (e.g., antenna, filters, and associated circuitry), an NFC interface, an RFID interface, a ZigBee interface, a FeliCa interface, a MiWi interface, Bluetooth interface, a BLE interface, or the like. In addition to being configured to enable communications between the node 100 and other mesh network nodes, the wireless radio 120 may be configured to encode and decode communications (e.g., packets) according to a protocol utilized by a mesh network to which the node 100 belongs.

The memory 124 may correspond to any type of non-transitory computer-readable medium. In some embodiments, the memory 124 may comprise volatile or non-volatile memory and a controller for the same. Non-limiting examples of memory 124 that may be utilized in the node 100 include RAM, ROM, buffer memory, flash memory, solid-state memory, or variants thereof.

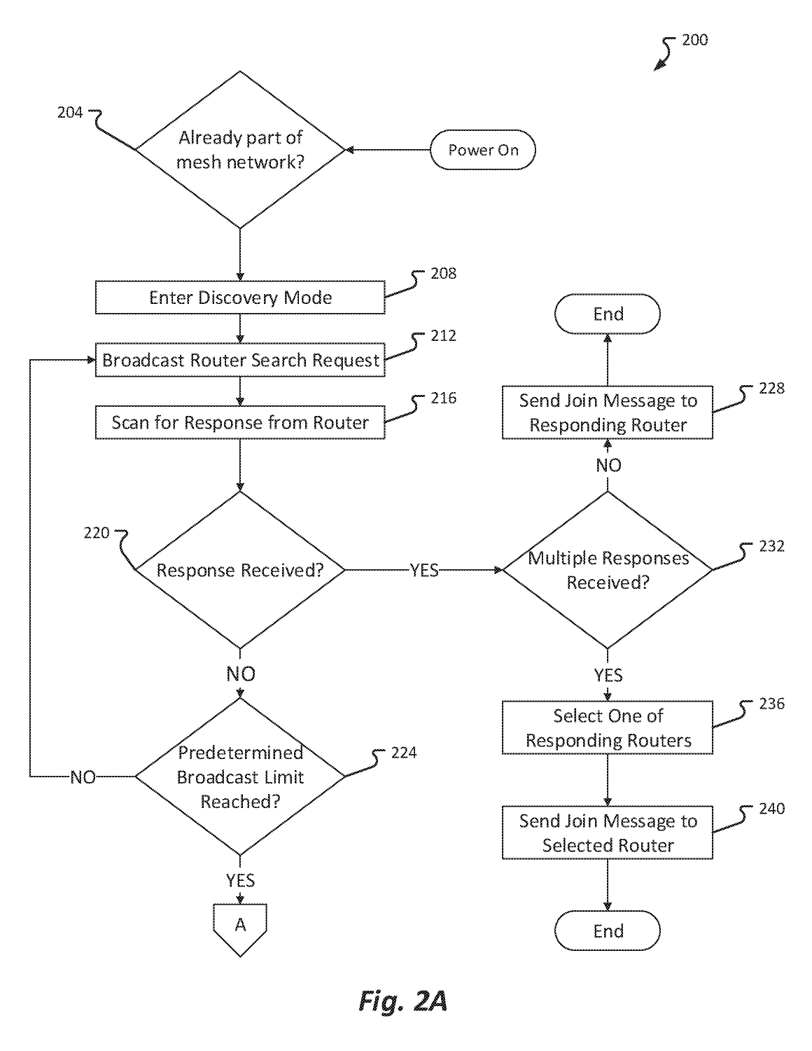

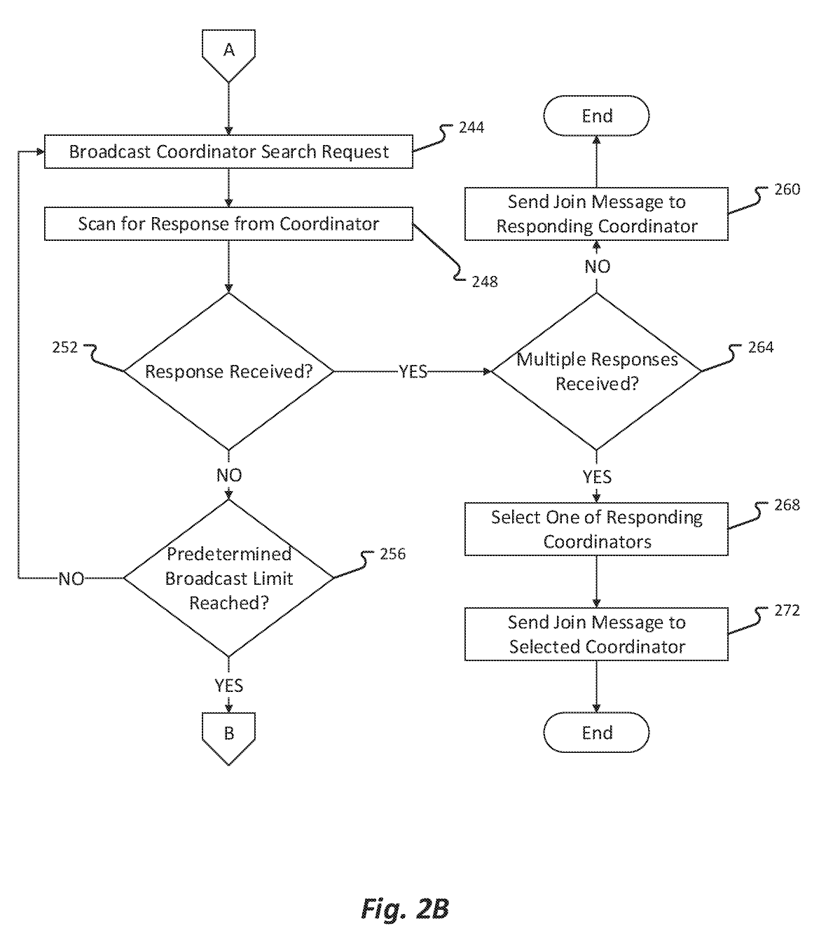

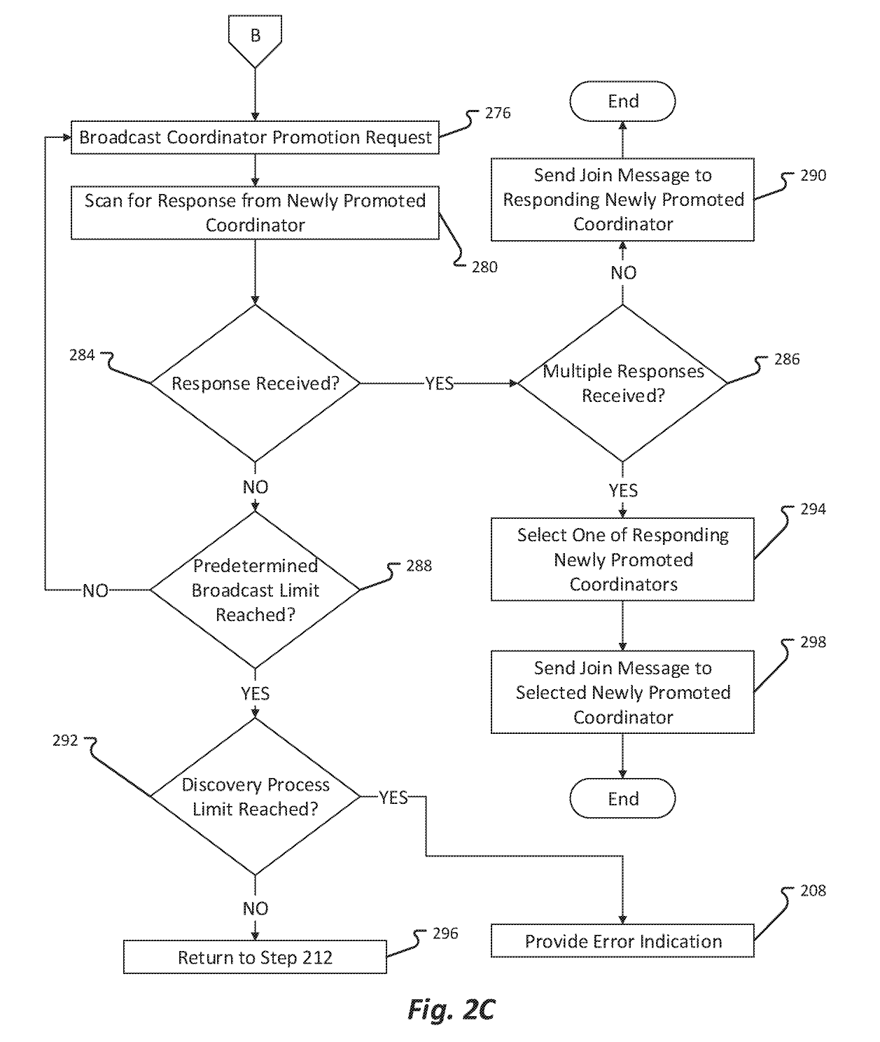

The memory 124 stores two broad categories of data, although these categories are not intended to be limiting. First, the memory 124 stores firmware 128, which comprises instructions for execution by the processor 104 for implementing one or more aspects of the present disclosure, including one or more aspects of the methods discussed herein with respect to FIGS. 2A, 2B, 2C, 3, and 4.

Second, the memory 124 comprises a data storage 132, for storing such information as data received from one or more connected devices via the data port(s) 116, drivers for the various components of the node 100, settings for the various components of the node 100 (including, for example, network or device information needed by the wireless radio 120 to establish and maintain a connection with a mesh network), and, if the node 100 belongs to a mesh network, information about the mesh network to which the node 100 belongs. Thus, if the node 100 is configured to continuously transmit data received via the data port(s) 116 over a mesh network using the wireless radio 120, but the node 100 loses its connection to the mesh network, the node 100 may be configured to store data in the data storage area 132 of the memory 124 until a connection with the mesh network is reestablished and the node 100 is able to upload the stored information through the mesh network. In some embodiments, to conserve available memory, the node 100 may be configured to store only a data summary, such as an average of a predetermined number of data points, or an average of received data points over time, or trend information, in the memory 124. The node 100 may temporarily store data points received via the data port(s) 116 until the data summary can be prepared, calculated, or identified, after which those data points may be deleted from the memory 124 or otherwise discarded. Storage of only data summary information may allow the node 100 to store data for a longer period of time than would be possible if the node 100 were configured to store every single data point received via the data port(s) 116.

In some embodiments, a node 100 according to the present disclosure may be configured to upload information through the mesh network on a periodic basis, rather than continuously. In these embodiments (as in embodiments where the node 100 is configured to upload received information continuously but loses its connection to the mesh network, as discussed above), the node 100 may be configured to store data or a data summary in the data storage area 132 of the memory 124 in between the periodic uploads of received data. This allows memory to be conserved and enables a longer period between uploads.

Turning now to FIG. 2A, a potential mesh network node (e.g. a self-promoting mesh network node that is not yet part of a mesh network) such as the node 100 is configured to implement the method 200 when joining a mesh network. Although the method 200 and the other methods described herein are described with respect to the node 100, persons of ordinary skill in the art will recognize that the methods described herein may be implemented on mesh network nodes or potential mesh network nodes that differ in one or more respects from the node 100, provided that the mesh network node or potential mesh network node is able to transmit signals to and receive signals from other nodes in a mesh network.

When the node 100 is powered on, the processor 104 of the node 100 first determines whether the node 100 is already part of a mesh network (step 204). This may involve, for example, transmitting a signal to and/or receiving a signal from another mesh network node, or determining whether the network information needed to connect to a specific mesh network is stored in the memory 124, or determining whether a mesh network identifier is stored in the memory 124. If the node 100 is not connected to a mesh network, then the node 100 may be configured to enter a discovery mode (step 208). In some embodiments, the node 100 may omit the step 204 of determining whether the node 100 is already part of a mesh network. For example, the node 100 may be configured to enter the discovery mode anytime it is powered on, and/or anytime it is reset (e.g. by an operator via the user interface elements 112).

In discovery mode, the node 100 broadcasts up to three different signals. The node 100 first broadcasts a router search request (step 212) and scans for a response (step 216). The router search request may be any signal to which a router of a mesh network, upon receipt of the router search request, would respond. In some embodiments, the router search request comprises information sufficient to allow a responding router to address a responsive signal directly to the new node 100. Such information may comprise, for example, an identifier of the new node 100. The router search request need not request any particular information, and indeed may not request any information (even though information may be sent by a router in response to the router search request), as long as it will be recognized by a router in the mesh network as a router search request. If any router in the mesh network is within range of the broadcast router search request signal, it will respond to the router search request signal by sending a network ID and an address to the new node 100. If multiple routers are within communication range of the broadcast signal, the node 100 will receive multiple network IDs and addresses. If such a response is received while the processor 104 is scanning for a response from a router, the processor 104 may cause the network ID and the address to be stored in the memory 124 of the node 100.

The processor 104 then determines whether a response to the router search request has been received (step 220). The determining whether a response to the router search request has been received may occur a predetermined period of time after the router search request was broadcast, or it may occur a predetermined period of time after (or immediately after) the scanning for a response from a router stops. Step 220 may comprise, for example, determining whether a network ID and an address have been stored in the data storage area 132 of the memory 124.

Upon determining that a response to the router search request has been received (step 220), the processor 104 determines whether one or multiple responses were received (step 232). The processor 104 may be configured to wait a predetermined period of time (e.g. one second, or five seconds, or ten seconds) after determining that a response to the router search request signal was received to determine whether multiple responses were received, or the processor 104 may simply make the determination as to whether multiple responses were received without any predetermined delay.

If at step 232 the processor 104 determines that only one response was received, then the processor 104 causes a join message to be sent to the responding router, based on the received network ID and address. The transmission of the join message indicates that the node 100 has accepted that router's invitation and assumed the address provided by that router, and therefore completes the process of joining the node 100 to the mesh network.

If at step 232 the processor 104 determines that multiple responses were received, then the processor 104 proceeds to select one of the responding routers to which to respond (step 236). The node 100 may select the first router that responded to the router search request, or it may be programmed with some other criteria or logic for selecting which among a plurality of routers (and associated mesh networks) to join. For example, in embodiments where mesh network node addressing is done in a manner that allows the position of a node within a mesh network to be determined based on the node address, like that described below, the processor 104 may be configured to select for response the router offering an address corresponding to the most favorable mesh network position (e.g. a position as close to the gateway/router of the mesh network as possible, to minimize the number of transmission steps that will be required to upload information from the node 100 to the cloud).

Once one of the responding routers has been selected, the node 100 transmits a join message to the selected router (step 240). Here again, the transmission of the join message indicates that the node 100 has accepted that router's invitation and assumed the address provided by that router, and therefore completes the process of j oining the node 100 to the mesh network to which the router belongs.

For a variety of reasons, the new node 100 may not receive an immediate response to its router search request even if there are routers within communication range of the new node 100. To ensure that the absence of a response to the router search request is due to the absence of a router within communication range of the new node 100, rather than some other reason (e.g., a router within communication range of the new node is busy with other mesh network communications and is not yet able to respond to the router search request), the new node 100 may be configured to repeat the router search request broadcast at predetermined intervals during a predetermined period of time, or until it receives a response from a router, whichever is shorter.

Thus, if the processor 104 makes a negative determination at step 220, then the processor 104 may make a determination as to whether a predetermined broadcast limit (for broadcasting a router search request) has been reached (step 224). For example, the node 100 may be configured with a predetermined broadcast limit of three, or of five, or of ten, router search request broadcasts. If the predetermined broadcast limit is three, then after an initial negative determination at step 220, the processor 104 will make a negative determination at step 224, will return to step 212, and will re-broadcast the router search request. The processor 104 will continue to loop back to step 212 following repeated negative determinations at step 220 until at step 224 the processor 104 determines that the router search request has been broadcast the predetermined number of times (e.g. three, or five, or ten). At that point, the processor 104 will proceed to step 244 of FIG. 2B (described below). Alternatively, in some embodiments, the processor 104 may determine whether a predetermined period of time has expired at step 224, rather than determining whether a predetermined broadcast limit has been reached.

Turning now to FIG. 2B, if the new node 100 does not receive a response to its router search request before the predetermined broadcast limit is reached or during the predetermined period of time, the new node 100 will broadcast a coordinator search request (step 244) and scan for a response (step 248). The coordinator search request may be any signal to which a coordinator node of a mesh network, upon receipt of the coordinator search request, would respond. In some embodiments, the coordinator search request comprises information sufficient to allow a responding coordinator node to address a responsive signal directly to the new node 100. Such information may comprise, for example, an identifier of the new node 100. The coordinator search request need not request any particular information, and indeed may not request any information (even though information may be sent by a coordinator node in response to the coordinator search request), as long as it has sufficient information contained therein to be recognized by a coordinator node as a coordinator search request. If a node within range of the broadcast signal is a coordinator node (e.g. a node that is in communication with a router), then the coordinator node will send its network ID and an address to the new node 100, and may also report the address to the router to ensure that the router does not assign the same address to any other node. If such a response is received by the new node 100 while the processor 104 is scanning for a response from a coordinator node, the processor 104 may cause the network ID and the address to be stored in the memory 124 of the node 100.

As discussed above with respect to the router search request, multiple coordinator nodes may be within range of the coordinator search request signal sent by the new node 100, and so the new node 100 may receive (and the processor 104 may cause to be stored in the memory 132) network IDs and addresses from multiple coordinator nodes.

The processor 104 next determines whether a response to the coordinator search request has been received (step 252). The determining whether a response to the coordinator search request is received may occur a predetermined period of time after the coordinator search request was broadcast, or it may occur a predetermined period of time after (including immediately after) the scanning for a response from a coordinator node stops. Step 252 may comprise, for example, determining whether a network ID and an address have been stored in the data storage area 132 of the memory 124.

Upon determining that a response to the coordinator search request has been received (step 252), the processor 104 determines whether one or multiple responses were received (step 264). As with step 232, the processor 104 may be configured to wait a predetermined period of time after determining that a response to the coordinator search request signal was received to determine whether multiple responses were received, or the processor 104 may simply make the determination as to whether multiple responses were received without any predetermined delay.

If at step 264 the processor 104 determines that only one response was received, then the processor 104 causes a join message to be sent to the responding coordinator node, based on the received network ID and address. The transmission of the join message indicates that the node 100 has accepted that coordinator node's invitation and assumed the address provided by the coordinator node, and therefore completes the process of joining the node 100 to the mesh network. The coordinator node reports receipt of the join message to its router, so that the router knows that the address provided by the coordinator node to the new node 100 is taken.

If at step 264 the processor 104 determines that multiple responses were received, then the processor 104 proceeds to select one of the responding coordinator nodes to which to respond (step 268). The node 100 may select a responding coordinator node using any of the same criteria discussed above with respect to step 236 for selecting a responding router.

Once one of the responding coordinator nodes has been selected, the node 100 transmits a join message to the selected coordinator node (step 272). Here again, the transmission of the join message indicates that the node 100 has accepted that coordinator node's invitation and assumed the address provided by that coordinator node, and therefore completes the process of joining the node 100 to the mesh network to which the coordinator node belongs. The coordinator node reports receipt of the join message to its router, so that the router knows that the address provided by the coordinator node to the new node 100 is taken.

Just as the new node 100 may not receive an immediate response to a router search request, the new node 100 may not receive an immediate response to a coordinator search request. Thus, if the processor 104 makes a negative determination at step 252, then the processor 104 may make a determination as to whether a predetermined broadcast limit for broadcasting a coordinator search request (which may be the same as or similar to the broadcast limit for broadcasting a router search request) has been reached (step 256). If the predetermined broadcast limit has not been reached, then after a negative determination at step 252, the processor 104 will make a negative determination at step 256, will return to step 244, and will re-broadcast the coordinator search request. The processor 104 will continue to loop back to step 244 following repeated negative determinations at step 252 until at step 256 the processor 104 determines that the coordinator search request has been broadcast the predetermined number of times. At that point, the processor 104 will proceed to step 276 of FIG. 2C (described below).

Alternatively, in some embodiments, the processor 104 may determine whether a predetermined period of time has expired at step 256 rather than determining whether a predetermined broadcast limit has been reached.

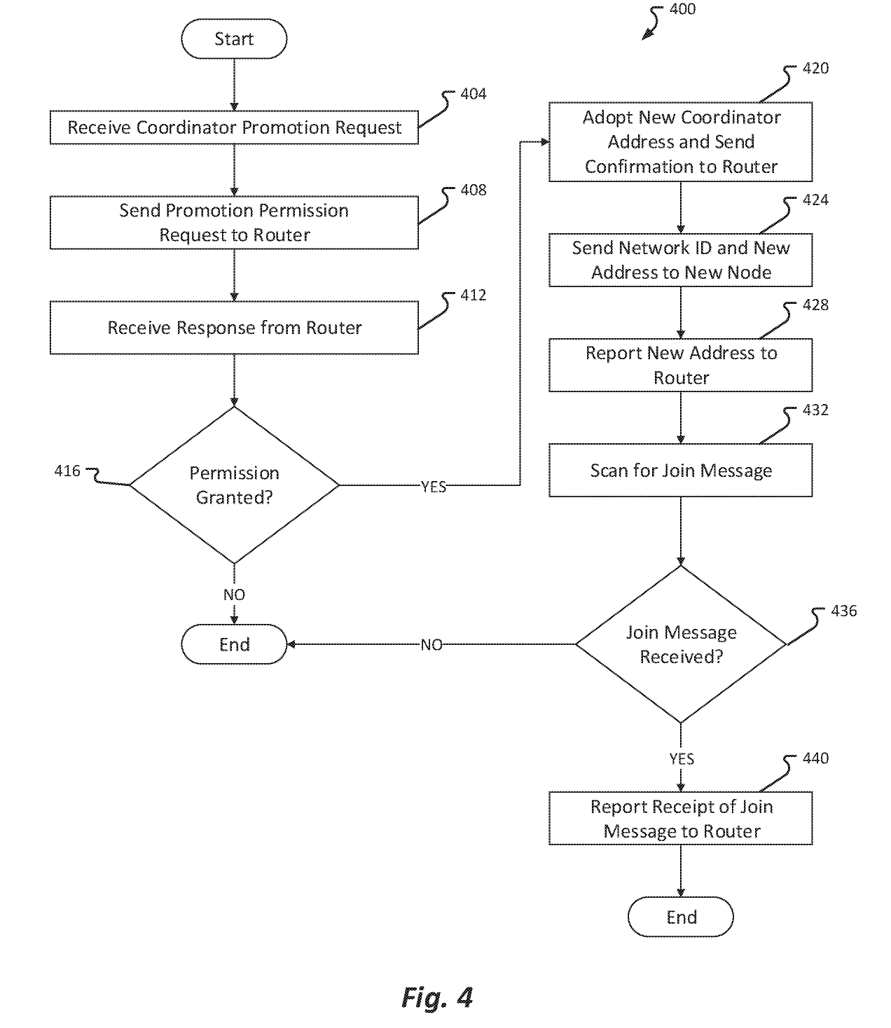

Turning now to FIG. 2C, if the new node 100 does not receive a response to its coordinator search request before the predetermined broadcast limit is reached or during the predetermined period of time, the new node 100 will broadcast a coordinator promotion request (step 276) and scan for a response from a newly promoted coordinator node (step 280). The coordinator promotion request may be any signal that might cause an existing mesh network node receiving the signal to transmit a coordinator promotion permission request to the router of the mesh network. In some embodiments, the coordinator promotion request comprises information sufficient to allow a responding, newly promoted coordinator to address a responsive signal directly to the new node 100. Such information may comprise, for example, an identifier of the new node 100. The process followed by a mesh network node upon receipt of a coordinator promotion request is described more fully in FIG. 4 and the accompanying description.

Once an existing node has adopted a new coordinator address, it initiates the same communication process with the new node and the router that is described above with respect to coordinator nodes responding to a coordinator search request.

Thus, the recently promoted coordinator node will send its network ID and an address to the new node 100, and may also report the address to the router to ensure that the router does not assign the same address to any other node. If such a response is received by the new node 100 while the processor 104 is scanning for a response to its coordinator promotion request, the processor 104 may cause the network ID and the address to be stored in the memory 124 of the node 100.

As discussed above with respect to the coordinator search request, multiple mesh network nodes may be within range of the new node's coordinator promotion request signal, and may follow the process described with respect to FIG. 4 to become coordinator nodes, so as to be able to respond to the coordinator promotion request from the new node 100. Thus, the new node 100 may receive (and the processor 104 may cause to be stored in the memory 132) network IDs and addresses from multiple newly promoted coordinator nodes.

The processor 104 next determines whether a response to the coordinator promotion request has been received (step 284). The determining whether a response to the coordinator promotion request has been received may occur a predetermined period of time after the coordinator promotion request was broadcast, or it may occur a predetermined period of time after (or immediately after) the scanning for a response from a newly promoted coordinator node stops. Such a predetermined period of time may be a longer predetermined period of time than with respect to steps 220 and 252, given the backend communications that must occur between an existing mesh network node and a router before the existing mesh network node can be promoted to a coordinator node and respond to the coordinator promotion request signal as a newly promoted coordinator node. Step 284 may comprise, for example, determining whether a network ID and an address have been stored in the data storage area 132 of the memory 124.

Upon determining that a response to the coordinator promotion request has been received (step 284), the processor 104 determines whether one or multiple responses were received (step 286). As with step 264, the processor 104 may be configured to wait a predetermined period of time after determining that a response to the coordinator promotion request signal was received to determine whether multiple responses were received, or the processor 104 may simply make the determination as to whether multiple responses were received without any predetermined delay.

If at step 286 the processor 104 determines that only one response was received, then the processor 104 causes a join message to be sent to the responding coordinator, based on the received network ID and address. The transmission of the join message indicates that the node 100 has accepted the newly promoted coordinator node's invitation and assumed the address provided by the newly promoted coordinator node, and therefore completes the process of joining the node 100 to the mesh network. The newly-promoted coordinator node reports receipt of the join message to its router, so that the router knows that the address provided by the newly-promoted coordinator node to the new node is taken.

If at step 286 the processor 104 determines that multiple responses were received, then the processor 104 proceeds to select one of the responding newly promoted coordinator nodes to which to respond (step 294). The node 100 may select a responding coordinator node using any of the same criteria discussed above with respect to step 236 for selecting a responding router.

Once one of the responding newly promoted coordinator nodes has been selected, the node 100 transmits a join message to the selected coordinator node (step 298). Here again, the transmission of the join message indicates that the node 100 has accepted that coordinator node's invitation and assumed the address provided by that coordinator node, and therefore completes the process of joining the node 100 to the mesh network to which the newly-promoted coordinator node belongs. The newly-promoted coordinator node reports receipt of the join message to its router, so that the router knows that the address provided by the newly-promoted coordinator node to the new node is taken.

If at step 284 the processor 104 determines that no response has been received, then the processor 104 may make a determination as to whether a predetermined broadcast limit for broadcasting a coordinator promotion request (which may be the same as or similar to the broadcast limit for broadcasting a router search request and/or a coordinator search request, and may in some embodiments be a predetermined period of time) has been reached (step 288). If the predetermined broadcast limit has not been reached, then after a negative determination at step 284, the processor 104 will make a negative determination at step 288, will return to step 276, and will re-broadcast the coordinator promotion request. The processor 104 will continue to loop back to step 276 following repeated negative determinations at step 284 until at step 288 the processor 104 determines that the coordinator promotion request has been broadcast the predetermined number of times.

At that point, the processor 104 may determine whether a predetermined discovery process limit has been reached (step 292). The predetermined discovery process limit may be, for example, a limit on the number of times that the new node 100 will cycle through the entire discovery process 200. The predetermined discovery process limit may also be a limit on the total amount of time that the new node 100 will spend cycling through the entire discovery process 200. If the processor 104 determines that the discovery process limit has not been reached, then the processor 104 will return to step 212 of FIG. 2a (step 296) and re-start the discovery process. If the processor 104 determines that the discovery process limit has been reached, then the processor 104 will cause an error indication to be output via the user interface element(s) 112 of the new node 100 (step 208). The indication may comprise a light flashing in a particular sequence or in a particular color, or a broadcast of an error message, or an audible signal, or a graphic or written message appearing on a display screen of the node 100, or any other type of indication. The error indication simply alerts the user or operator of the node 100 that the node 100 has been unsuccessful in joining a mesh network.

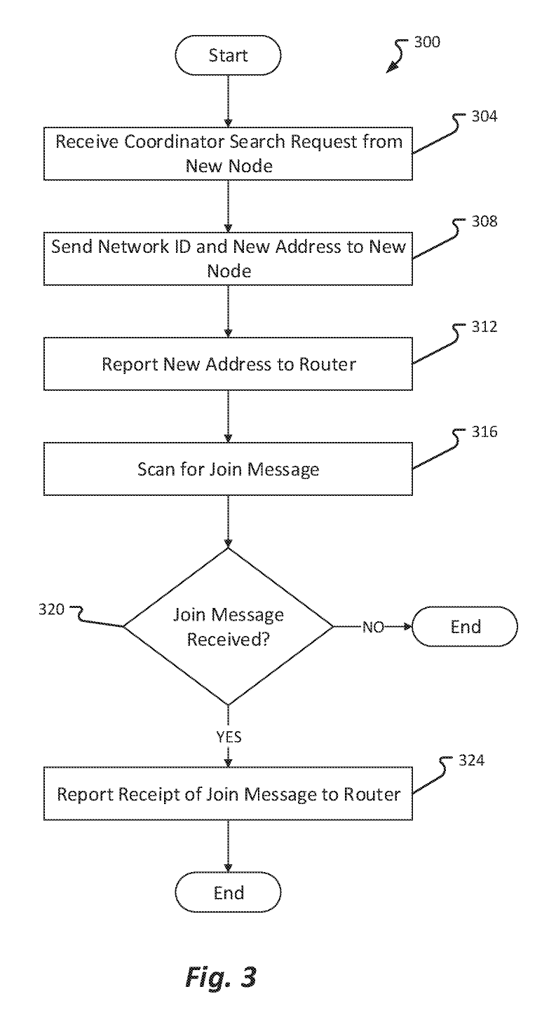

With reference now to FIG. 3, a method 300 of a coordinator node responding to a coordinator search request received from a new node 100 begins when the coordinator node receives the coordinator search request signal from the new node 100 (step 304). A coordinator node may have the same or similar components as the new node 100. Upon receiving the coordinator search request signal (e.g. via the coordinator node's own wireless radio), a processor of the coordinator node generates a response comprising a network ID for the mesh network to which the coordinator belongs, as well as a new mesh network address for the new node 100, which response is transmitted via the wireless radio of the coordinator node to the new node 100 (step 308).

To ensure that another new node is not assigned the same new mesh network address sent by the coordinator node to the new node 100, the coordinator node may report the new mesh network address to the router of the mesh network to which the coordinator node belongs (step 312). In some embodiments, the router may then transmit a message to other coordinator nodes in the mesh network that alerts the other coordinator nodes of the address that has been sent to the new node 100, so that the other coordinator nodes do not assign the same address to additional new nodes. In other embodiments, the address sent to the new node 100 need not be reported to the router, because the mesh network addresses that each coordinator node can assign are specific to that coordinator node (such that one coordinator node of a mesh network would never assign the same address to a new node as another coordinator node in the mesh network).

After sending the network ID and new address to the new node 100 in step 308, the coordinator node scans for a join message from the new node 100 (step 316). A join message indicates that the new node has assumed the new mesh network address provided in step 308 and is now part of the mesh network. Whether continuously during the scanning step, periodically during the scanning step, or after a predetermined period of time has passed since the scanning step began, a processor of the coordinator node determines whether a join message has been received (step 320). If no join message has been received, then the method 300 ends. In some embodiments, the coordinator node may report that no join message was received to the router, so that the router no longer reserves the new address that was sent to the new node 100, making that address available for another new node from which a router search request, a coordinator search request, or a coordinator promotion request is received.

If at step 320 a processor of the coordinator node determines that a join message has been received, then the coordinator node reports receipt of the join message (and, if necessary, the address of the new node 100) to the router (step 324). This allows the router to maintain an accurate record of nodes of the mesh network, and concludes the method 300.

With respect to FIG. 4, a method 400 of an existing mesh network end node responding to a coordinator promotion request received from a new node 100 begins when the existing mesh network end node receives the coordinator promotion request signal from the new node 100 (step 404). The existing mesh network end node may have the same or similar components as the new node 100. The receipt of a coordinator promotion request indicates that the new node 100 is not within communication range of the mesh network router or of any existing mesh network coordinator nodes, such that an existing mesh network end node needs to be promoted to a coordinator node.

Upon receipt of the coordinator promotion request, then, the existing mesh network end node sends a promotion permission request to the mesh network router (408). The promotion permission request indicates (whether by its content or by the fact of its transmission) that the existing mesh network end node has received a coordinator promotion request from a new node and needs to be promoted to a coordinator node in order to add the new node to the mesh network.

The existing mesh network end node then receives a response to the promotion permission request from the router (step 412). A processor of the existing mesh network end node then analyzes the response and determines whether the router has granted permission to existing mesh network end node to promote itself to a coordinator node or not (step 416).

A router may deny a coordinator promotion request. For example, if multiple existing mesh network end nodes are within communication range of and receive the coordinator promotion request sent by the new node 100, then the router may receive multiple self-promotion messages. To avoid needlessly promoting multiple nodes to be coordinator nodes, the router may be configured to grant coordinator promotion permission only once in a predetermined period of time (e.g. once every 5 seconds). This allows time for the promoted node to send the network ID and an address to the new node, determine whether the new node has accepted the address with a join message, and report back to the router. If the router receives additional promotion requests after the predetermined time period has expired, then it can assume that other nodes require attention (e.g. another new node has sent out a coordinator promotion request, such that another node needs permission to self-promote to a coordinator node) and grant another node permission to self-promote to a coordinator node. A router may also deny a coordinator promotion request if, for example, the size of the mesh network is capped and that cap has been reached. If in step 416 the processor of the existing mesh network node determines that permission has not been granted, then the method 400 ends.

When the router grants a promotion permission request, the response it sends to the requesting node includes a new coordinator address for the requesting node. Thus, if in step 416 the existing mesh network node determines that the router has granted permission, then the existing mesh network node adopts the new address provided by the router and sends a confirmation to the router (step 420). The processor of the newly promoted coordinator node can then generate a message containing a network ID of the mesh network and a new mesh network address, and can send that message to the new node 100 (e.g. the node that sent the coordinator promotion request) via the newly promoted coordinator node's wireless radio (step 424). As when an existing coordinator node responds to a coordinator search request with a new address for the requesting node, the newly promoted coordinator node may report the new address sent to the new node 100 to the mesh network router (step 428). However, as discussed above with respect to step 312 of FIG. 3, the newly promoted coordinator node may omit this step.

After sending the network ID and new address to the new node 100 in step 424, the newly promoted coordinator node scans for a join message from the new node 100 (step 432). As before, a join message indicates that the new node has assumed the new mesh network address provided in step 424 and is now part of the mesh network. Whether continuously during the scanning step, periodically during the scanning step, or after a predetermined period of time has passed since the scanning step began, a processor of the coordinator node determines whether a join message has been received (step 436). If no join message has been received, then the method 400 ends. In some embodiments, the coordinator node reports that no join message was received to the router, so that the router no longer reserves the new address that was sent to the new node 100, making that address available for another new node from which a router search request, a coordinator search request, or a coordinator promotion request is received.

If at step 436 a processor of the coordinator node determines that a join message has been received, then the coordinator node reports receipt of the join message (and, if necessary, the address of the new node 100) to the router (step 440). This allows the router to maintain an accurate record of nodes of the mesh network, and concludes the method 400.

Variations of the foregoing description are both possible and within the scope of the present disclosure. For example, new addresses may be generated by a central server in communication with the mesh network rather than by a node in the mesh network. In such embodiments, the node receiving the broadcast signal from the new node 100 may send a message to the central server (via the mesh network router) requesting a new address, which message is then forwarded to the new node 100 upon receipt from the central server. As another example, a coordinator node may communicate with the mesh network router to obtain an address to provide to the new node 100 in response to a coordinator search request, rather than determining on its own which address to send to the new node 100. As another example (and as discussed above), the coordinator node may not report that it has sent an address to a new node until the new node has responded with a join message, such that the coordinator node knows that the address has been taken. As yet another example, the coordinator node may simply forward communications from the new node 100 to the mesh network router and from the mesh network router to the new node 100, without independently processing or responding to those communications.

If two nodes attempt to join a mesh network simultaneously and are offered the same mesh network address, and both nodes accept the same mesh network address by sending a join message to the mesh network router or to the coordinator node (which subsequently forwards the join message to the mesh network router or otherwise confirms the join message to the mesh network router), the router can respond to one of the join messages with a conflict message and a new, non-conflicting address.

In some embodiments, the mesh network router may send a disconnect message to a node in its mesh network. This message may originate, for example, at a central server from which the mesh network is being controlled or managed. If a node receives a disconnect message, the node reenters discovery mode and searches for a mesh network with a different network ID to join, using the same discovery process described above. Alternatively, the disconnect message may provide a different network ID and address so that the disconnected node can immediately join a different mesh network. Similarly, if a node loses its connection with the mesh network—whether due to a power failure, an equipment failure, or otherwise—the node reenters discovery mode and attempts to reestablish a connection with a mesh network using the same discovery process described above. The node may be configured to attempt to reestablish a connection with the same network to which it previously belonged, or it may be configured to attempt to reestablish a connection with any available network. The node may also be configured with logic for prioritizing different mesh networks so that it can join the highest priority mesh network available. Such logic may be based on, for example, a network ID ordering system (e.g. in a given facility, mesh networks that have reached a desired capacity may include an indication to that effect in their network IDs, and new nodes may be configured not to join mesh networks whose network IDs include such an indication), an assigned address (e.g. the node may be configured to accept the address that indicates that the associated mesh network has the greatest capacity for growth or the most available network bandwidth), the order in which responses to a broadcast signal were received (e.g. the node may be configured to accept the first response, or the second response, or the last response), or any other available information.

In some embodiments, the signals broadcast by the new node 100, or the join message sent by the new node 100 to accept an offered address may include a unique serial number associated with the new node 100. This serial number may be used to track which specific equipment is associated with a given mesh network, or a router or coordinator may use the unique serial number to determine whether the new node 100 is approved to join the router's or coordinator node's mesh network (e.g. by comparing the unique serial number to a list of approved unique serial numbers, which may be stored locally (for example, in the memory of the mesh network router), or may be available on the Internet). In other embodiments, a mesh network router (or a server in communication with the router) can provide a unique serial number to a new node 100. Unique serial numbers are particularly useful where multiple mesh networks are managed from a single server, as the same mesh network address may exist on multiple mesh networks. Additionally, when a particular node sends data to the mesh network router for transmission outside of the mesh network (e.g. over the Internet), the unique serial number of the new node 100 can be associated with the data so that the data source is known.

Self-promoting nodes according to the present disclosure need not store an address list with the address of other nodes in the mesh network. Instead, the addresses assigned to each node contain all the information necessary to transmit and receive data across the mesh network. For example, a mesh network may contain one mesh network router, two first-level coordinator nodes, each with two second-level coordinator nodes, each with three end nodes. Any given node's address reflects the level and number of the node itself and of all intermediate nodes between the node in question and the router. The nodes of this mesh network may have the following addresses:

| | |
|---|---|
| Router | 0000 |
| First-Level Coordinator Node 1 | 0100 |
| First-Level Coordinator Node 2 | 0200 |
| Second-Level Coordinator Node 1 | 1100 |
| attached to 0100 | |
| Second-Level Coordinator Node 2 | 2100 |
| attached to 0100 | |
| Second-Level Coordinator Node 1 | 1200 |
| attached to 0200 | |
| Second-Level Coordinator Node 2 | 2200 |
| attached to 0200 | |
| End Node 1 attached to 1100 | 1101 |
| End Node 2 attached to 1100 | 1102 |
| End Node 3 attached to 1100 | 1103 |
| End Node 1 attached to 2100 | 2101 |
| End Node 2 attached to 2100 | 2102 |
| End Node 3 attached to 2100 | 2103 |
| End Node 1 attached to 1200 | 1201 |
| End Node 2 attached to 1200 | 1202 |
| End Node 3 attached to 1200 | 1203 |
| End Node 1 attached to 2200 | 2201 |
| End Node 2 attached to 2200 | 2202 |
| End Node 3 attached to 2200 | 2203 |

Using addresses formatted in this way, the address itself is sufficient to allow the mesh network to determine the proper communication path to send data from one node to another, as each node that receives the message need only compare the destination address with its own address to determine whether to send the message up one level (e.g. from a second-level coordinator node to a first-level coordinator node) or down one level (e.g. from a first-level coordinator node to a second-level coordinator node, or from a second-level coordinator node to an end node).

Specific details were given in the foregoing description to provide a thorough understanding of the embodiments. However, it will be understood by one of ordinary skill in the art that the embodiments may be practiced without these specific details. Persons of ordinary skill in the art will also understand that various embodiments described above may be used in combination with each other without departing from the scope of the present disclosure. In this disclosure, well-known circuits, processes, algorithms, structures, hardware, and techniques have been shown and described without unnecessary detail in order to avoid obscuring the embodiments.

To avoid unnecessarily obscuring the present disclosure, the preceding description omits a number of known structures and devices. This omission is not to be construed as a limitation of the scopes of the claims. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Any of the steps, functions, and operations discussed herein can be performed continuously and automatically.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FXTM family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, and other industry-equivalent processors. A processor as disclosed herein may perform computational functions using any known or future-developed standard, instruction set, libraries, and/or architecture.

What is claimed is:

1. A self-promoting mesh network node, comprising:
a wireless radio for communicating with other nodes in a mesh network;
a processor; and
a memory storing instructions configured to cause the processor to:
detect whether the self-promoting mesh network node has a mesh network address;
broadcast a router search request from the wireless radio if no mesh network address is detected;
broadcast a coordinator search request from the wireless radio if no mesh network address is received from a router in response to the router search request after a first predetermined period of time;
broadcast a coordinator promotion request from the wireless communication interface if no mesh network address is received from a coordinator in response to the coordinator search request after a second predetermined period of time; and
adopt a mesh network address received in response to one of the router search request, the coordinator search request, and the coordinator promotion request.

2. The self-promoting mesh network node of claim 1, wherein the memory further stores instructions configured to cause the processor to:
detect a coordinator promotion request received via the wireless radio;
send a promotion permission request to a router; and
adopt a coordinator address received from the router.

3. The self-promoting mesh network node of claim 2, wherein the memory further stores instructions configured to cause the processor to:
send a new mesh network address via the wireless radio in response to the coordinator promotion request;
detect a join message received via the wireless radio; and
send a message to the router including the new mesh network address.

4. The self-promoting mesh network node of claim 1, wherein the memory further stores instructions configured to cause the processor to:
send a new mesh network address via the wireless radio in response to a coordinator search request;
detect a join message received via the wireless radio; and
send a message to a router including the new mesh network address.

5. The self-promoting mesh network node of claim 1, wherein the memory further stores instructions configured to cause the processor to:
send a join message to the node that sent the adopted mesh network address.

6. The self-promoting mesh network node of claim 1, wherein the memory further stores instructions configured to cause the processor to:
select for adoption, based on a predetermined criterion, one of a plurality of mesh network addresses received in response to one of the router search request, the coordinator search request, and the coordinator promotion request.

7. The self-promoting mesh network node of claim 6, wherein the predetermined criterion is related to the order in which the plurality of mesh network addresses were received.

8. The self-promoting mesh network node of claim 1, wherein the memory further stores instructions configured to cause the processor to adopt the first one of a plurality of mesh network addresses received in response to one of the router search request, the coordinator search request, and the coordinator promotion request.

9. The self-promoting mesh network node of claim 1, wherein the memory further stores instructions configured to cause the processor to broadcast the router search request at predetermined intervals of time during the first predetermined period of time.

10. The self-promoting mesh network node of claim 1, wherein the memory further stores instructions configured to cause the processor to broadcast the coordinator search request at predetermined intervals of time during the second predetermined period of time.

11. The self-promoting mesh network node of claim 1, wherein the memory further stores instructions configured to cause the processor to rebroadcast the router search request if no response is received to the coordinator promotion request.

12. A method of automatically configuring nodes of a mesh network, comprising:
broadcasting a router search request from a wireless radio on a mesh network node at predetermined intervals during a first period of time;
scanning for a response to the router search request until the first period of time has expired;
broadcasting a coordinator search request from the wireless radio at predetermined intervals during a second period of time, if no response to the router search request is detected;
scanning for a response to the coordinator search request until the second period of time has expired;
broadcasting a coordinator promotion request from the wireless radio at predetermined intervals during a third period of time, if no response to the coordinator search request is detected; and
scanning for a response to the coordinator search request until the third period of time has expired.

13. The method of claim 12, wherein the response to the router search request, the response to the coordinator search request, or the response to the coordinator promotion request comprises a mesh network address.

14. The method of claim 12, further comprising:
sending a join message, via the wireless radio, after receipt of the response to one of the router search request, the coordinator search request, and the coordinator promotion request.

15. A self-promoting mesh network node, comprising:
a communications transceiver for communicating with a plurality of nodes in a mesh network;
a processor; and
a memory storing instructions for causing the processor to:
detect a coordinator promotion request received via the communications transceiver;
generate a promotion permission request;
cause the promotion permission request to be sent to a mesh network router via the communications transceiver;
detect a response received from the mesh network router; and
determine, based on the response, whether the promotion permission request was granted by the mesh network router.

16. The self-promoting mesh network node of claim 15, wherein the memory stores additional instructions further causing the processor to:
adopt a new coordinator address contained within the response from the mesh network router;
generate a confirmation message indicating that the new coordinator address has been adopted; and
cause the confirmation message to be transmitted to the mesh network router via the communications transceiver.

17. The self-promoting mesh network node of claim 15, wherein the memory stores additional instructions further causing the processor to:
generate a message comprising a mesh network identifier and a new mesh network address; and
cause the message to be transmitted by the communications transceiver.

18. The self-promoting mesh network node of claim 17, wherein the memory stores additional instructions further causing the processor to detect a node identifier in the coordinator promotion request, the node identifier corresponding to a node that transmitted the coordinator promotion request; and further wherein the causing the message to be transmitted by the communications transceiver comprises causing the message to be transmitted by the communications transceiver to the node that transmitted the coordinator promotion request using the node identifier.

19. The self-promoting mesh network node of claim 17, wherein the memory stores additional instructions further causing the processor to scan for a join message after causing the message to be transmitted by the communications transceiver.

20. The self-promoting mesh network node of claim 19, wherein the memory stores additional instructions further causing the processor to report receipt of the joint message to the mesh network router.
